(19) United States
(12) Patent Application Publication
(10) Pub. No.: US 2024/0298228 A1
(43) Pub. Date: Sep. 5, 2024

(54) CELL RESELECTION METHOD AND USER EQUIPMENT

(71) Applicant: KYOCERA Corporation, Kyoto (JP)

(72) Inventors: Masato FUJISHIRO, Yokohama-shi (JP); Mitsutaka HATA, Yokohama-shi (JP)

(73) Assignee: KYOCERA Corporation, Kyoto (JP)

(21) Appl. No.: 18/640,837

(22) Filed: Apr. 19, 2024

Related U.S. Application Data
(63) Continuation of application No. PCT/JP2022/038735, filed on Oct. 18, 2022.

(30) Foreign Application Priority Data
Oct. 20, 2021 (JP) 2021-171987

(51) Int. Cl. H04W 36/00; H04W 36/30

(52) U.S. Cl. CPC H04W 36/008357; H04W 36/304

(57) ABSTRACT

A cell reselection method performed by a user equipment in a mobile communication system includes: receiving, from a network, slice frequency information indicating a correspondence relationship between network slice groups, frequencies, and frequency priorities; determining, for a selected network slice group selected by a user equipment in accordance with a slice group priority, priority orders of corresponding frequencies based on the frequency priorities indicated by the slice frequency information; and reselecting a candidate cell satisfying a predetermined quality standard within a selected frequency selected by the user equipment in accordance with the determined priority orders. The determining of the priority orders includes determining, for each of the frequencies, the priority orders of the corresponding frequencies, based on a maximum value of the frequency priorities for each of a plurality of network slice groups when the plurality of network slice groups have a same slice group priority.

### RELATED APPLICATIONS

The present application is a continuation based on PCT Application No. PCT/JP2022/038735, filed on Oct. 18, 2022, which claims the benefit of Japanese Patent Application No. 2021-171987 filed on Oct. 20, 2021. The content of which is incorporated by reference herein in their entirety.

### TECHNICAL FIELD

The present disclosure relates to a cell reselection method and a user equipment used in a mobile communication system.

### BACKGROUND OF INVENTION

In specifications of the Third Generation Partnership Project (3GPP), which is a standardization project for mobile communication systems, Network Slicing has been defined (for example, see Non-Patent Document 1). Network slicing is a technique for configuring a network slice that is a virtual network by logically dividing a physical network constructed by a telecommunications carrier.

### CITATION LIST

### Non-Patent Literature

Non-Patent Document 1: 3GPP TS 38.300 V16.6.0 (2021-06)

### SUMMARY

In a first aspect, a cell reselection method is performed by a user equipment in a mobile communication system. The cell reselection method includes: receiving, from a network, slice frequency information indicating a correspondence relationship between network slice groups, frequencies, and frequency priorities; determining, for a selected network slice group selected by a user equipment in accordance with a slice group priority, priority orders of corresponding frequencies based on the frequency priorities indicated by the slice frequency information; and reselecting a candidate cell satisfying a predetermined quality standard within a selected frequency selected by the user equipment in accordance with the determined priority orders. The determining of the priority orders includes determining, for each of the frequencies, the priority orders of the corresponding frequencies, based on a maximum value of the frequency priorities for each of a plurality of network slice groups when the plurality of network slice groups have a same slice group priority.

In second aspect, a user equipment includes a processor. The processor performs: processing of receiving, from a network slice frequency information indicating a correspondence relationship between network slice groups, frequencies, and frequency priorities; processing of determining, for a selected network slice group selected by the user equipment in accordance with a slice group priority, priority orders of corresponding frequencies based on the frequency priorities indicated by the slice frequency information; and processing of reselecting a candidate cell satisfying a predetermined quality standard within a selected frequency selected by the user equipment in accordance with the determined priority orders. The processing of determining the priority orders includes processing of determining, for each of the frequencies, the priority orders of the corresponding frequencies, based on a maximum value of the frequency priorities for each of a plurality of network slice groups when the plurality of network slice groups have a same slice group priority.

In a third aspect, a cell reselection method is performed by a user equipment in a mobile communication system. The cell reselection method includes: assigning, in a non-access stratum (NAS), a slice priority to each of one or more network slices; and notifying, by the NAS, an access stratum (AS) of slice information having the assigned slice priority. The assigning includes assigning different slice priorities to two or more network slices so that a same slice priority is not assigned to the two or more network slices.

In a fourth aspect, a cell reselection method is performed by a user equipment in a mobile communication system. The cell reselection method includes: assigning, in a non-access stratum (NAS), a slice priority to each of one or more network slices; and notifying, by the NAS, an access stratum (AS) of slice information having the assigned slice priority. The assigning includes specifying a network slice with a pending protocol data unit (PDU) session. The notifying includes notifying the AS of information based on the specified network slice.

### BRIEF DESCRIPTION OF THE DRAWINGS

FIG. 1 is a diagram illustrating a configuration of a mobile communication system according to an embodiment.

FIG. 2 is a diagram illustrating a configuration of a user equipment (UE) according to an embodiment.

FIG. 3 is a diagram illustrating a configuration of a base station (gNB) according to an embodiment.

FIG. 4 is a diagram illustrating a configuration of a protocol stack of a radio interface of a user plane handling data.

FIG. 5 is a diagram illustrating a configuration of a protocol stack of a radio interface of a control plane handling signaling (control signal).

FIG. 6 is a diagram for illustrating an overview of a cell reselection procedure.

FIG. 7 is a flowchart illustrating a schematic flow of a typical cell reselection procedure.

FIG. 8 is a diagram illustrating an example of network slicing.

FIG. 9 is a diagram illustrating an overview of a slice-specific cell reselection procedure.

FIG. 10 is a view illustrating an example of slice frequency information.

FIG. 11 is a flowchart illustrating a basic flow of the slice-specific cell reselection procedure.

FIG. 12 is a diagram for illustrating a first variation of the slice-specific cell reselection procedure.

FIG. 13 is a flowchart illustrating a flow of the first variation of the slice-specific cell reselection procedure.

FIG. 14 is a flowchart illustrating a flow of a second variation of the slice-specific cell reselection procedure.

FIG. 15 is a flowchart illustrating a flow of a third variation of the slice-specific cell reselection procedure.

FIG. 16 is a diagram for illustrating a fourth variation of the slice-specific cell reselection procedure.

FIG. 17 is a flowchart illustrating a flow of the fourth variation of the slice-specific cell reselection procedure.

### DESCRIPTION OF EMBODIMENTS

A user equipment in a radio resource control (RRC) idle state or an RRC inactive state performs a cell reselection procedure. In the 3GPP, slice-specific cell reselection that is a network slice-dependent cell reselection procedure is under study.

In such slice-specific cell reselection, for example, it is assumed that the user equipment preferentially reselects (that is, camps on) a cell belonging to a frequency having a high frequency priority associated with a network slice that the user equipment wants to use (intended slice). However, a specific method of the slice-specific cell reselection is not yet determined.

The present disclosure relates to a cell reselection method for facilitating slice-specific cell reselection.

A mobile communication system according to an embodiment is described with reference to the drawings. In the description of the drawings, the same or similar parts are denoted by the same or similar reference signs.

### Configuration of Mobile Communication System

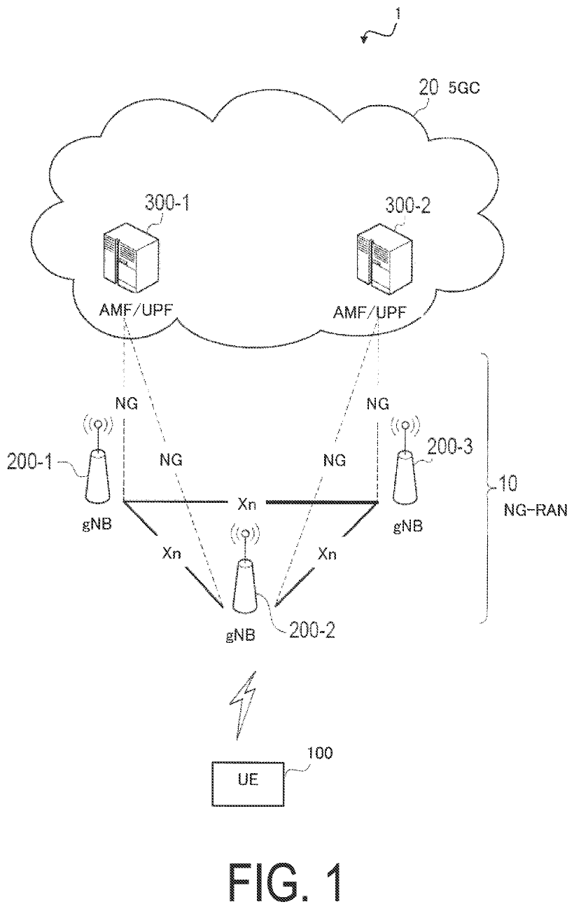

FIG. 1 is a diagram illustrating a configuration of a mobile communication system according to an embodiment. The mobile communication system 1 complies with the 5th Generation System (5GS) of the 3GPP standard. The description below takes the 5GS as an example, but a Long Term Evolution (LTE) system or a sixth generation (6G) system may be at least partially applied to the mobile communication system.

The mobile communication system 1 includes a User Equipment (UE) 100, a 5G radio access network (Next Generation Radio Access Network (NG-RAN)) 10, and a 5G Core Network (5GC) 20. The NG-RAN 10 may be hereinafter simply referred to as a RAN 10. The 5GC 20 may be simply referred to as a core network (CN) 20.

The UE 100 is a mobile wireless communication apparatus. The UE 100 may be any apparatus as long as utilized by a user. Examples of the UE 100 include a mobile phone terminal (including a smartphone), a tablet terminal, a notebook PC, a communication module (including a communication card or a chipset), a sensor or an apparatus provided on a sensor, a vehicle or an apparatus provided on a vehicle (Vehicle UE), or a flying object or an apparatus provided on a flying object (Aerial UE).

The NG-RAN 10 includes base stations (referred to as “gNBs” in the 5G system) 200. The gNBs 200 are interconnected via an Xn interface which is an inter-base station interface.

Each gNB 200 manages one or more cells. The gNB 200 performs wireless communication to the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency (also simply referred to as a “frequency” below).

Note that the gNB can be connected to an Evolved Packet Core (EPC) corresponding to a core network of LTE. An LTE base station can also be connected to the 5GC. The LTE base station and the gNB can be connected via an inter-base station interface.

The 5GC 20 includes an Access and Mobility Management Function (AMF) and a User Plane Function (UPF) 300. The AMF performs various types of mobility controls and the like for the UE 100. The AMF manages mobility of the UE 100 by communicating with the UE 100 by using Non-Access Stratum (NAS) signaling. The UPF controls data transfer. The AMF and UPF are connected to the gNB 200 via an NG interface which is an interface between a base station and the core network.

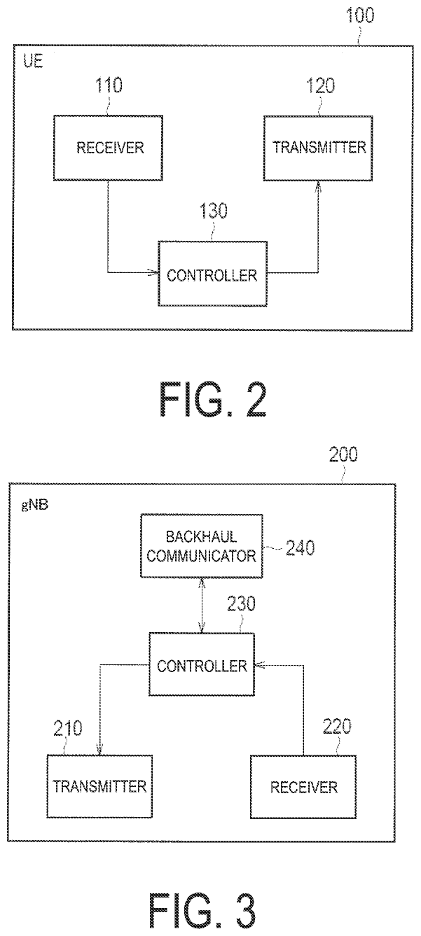

FIG. 2 is a diagram illustrating a configuration of the user equipment (UE) 100 according to the embodiment. The UE 100 includes a receiver 110, a transmitter 120, and a controller 130. The receiver 110 and the transmitter 120 constitute a wireless communicator that performs wireless communication with the gNB 200.

The receiver 110 performs various types of reception under control of the controller 130. The receiver 110 includes an antenna and a reception device. The reception device converts a radio signal received through the antenna into a baseband signal (a reception signal) and outputs the resulting signal to the controller 130.

The transmitter 120 performs various types of transmission under control of the controller 130. The transmitter 120 includes an antenna and a transmission device. The transmission device converts a baseband signal (a transmission signal) output by the controller 130 into a radio signal and transmits the resulting signal through the antenna.

The controller 130 performs various types of control and processes in the UE 100. Such processing includes processing of each layer described below. The controller 130 includes at least one processor and at least one memory. The memory stores a program to be executed by the processor and information to be used for processing by the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing.

FIG. 3 is a diagram illustrating a configuration of the gNB 200 (base station) according to the embodiment. The gNB 200 includes a transmitter 210, a receiver 220, a controller 230, and a backhaul communicator 240. The transmitter 210 and the receiver 220 constitute a wireless communicator that performs wireless communication with the UE 100. The backhaul communicator 240 constitutes a network communicator that performs communication with the CN 20.

The transmitter 210 performs various types of transmission under control of the controller 230. The transmitter 210 includes an antenna and a transmission device. The transmission device converts a baseband signal (a transmission signal) output by the controller 230 into a radio signal and transmits the resulting signal through the antenna.

The receiver 220 performs various types of reception under control of the controller 230. The receiver 220 includes an antenna and a reception device. The reception device converts a radio signal received through the antenna into a baseband signal (a reception signal) and outputs the resulting signal to the controller 230.

The controller 230 performs various types of control and processes in the gNB 200. Such processing includes processing of each layer described below. The controller 230 includes at least one processor and at least one memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing.

The backhaul communicator 240 is connected to a neighboring base station via the Xn interface, which is an inter-base station interface. The backhaul communicator 240 is connected to the AMF/UPF 300 via the NG interface, which is an interface between the base station and the core network. Note that the gNB 200 may include a Central Unit (CU) and a Distributed Unit (DU) (i.e., functions are divided), and the two units may be connected via an F1 interface, which is a fronthaul interface.

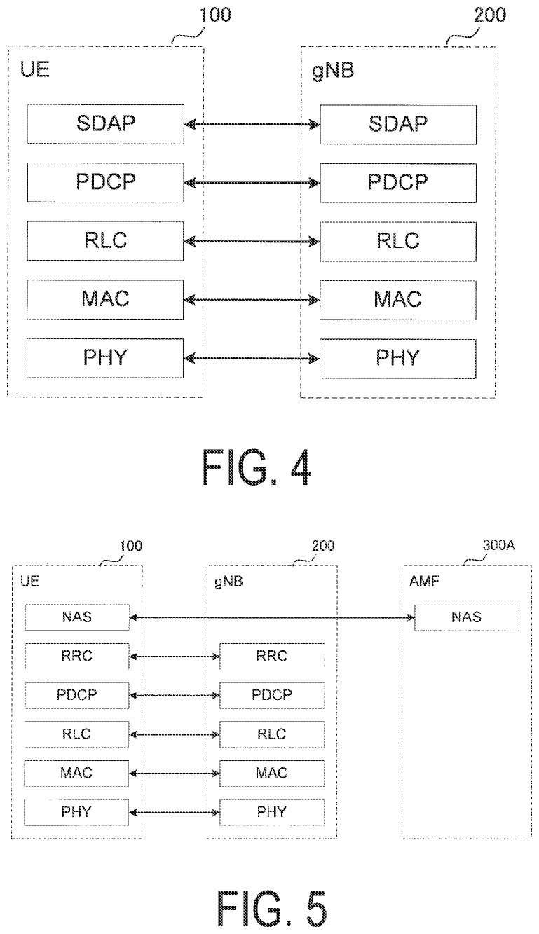

FIG. 4 is a diagram illustrating a configuration of a protocol stack of a radio interface of a user plane handling data.

A radio interface protocol of the user plane includes a physical (PHY) layer, a Medium Access Control (MAC) layer, a Radio Link Control (RLC) layer, a Packet Data Convergence Protocol (PDCP) layer, and a Service Data Adaptation Protocol (SDAP) layer.

The PHY layer performs coding and decoding, modulation and demodulation, antenna mapping and demapping, and resource mapping and demapping. Data and control information are transmitted between the PHY layer of the UE 100 and the PHY layer of the gNB 200 via a physical channel. The PHY layer of the UE 100 receives downlink control information (DCI) transmitted from the gNB 200 over a physical downlink control channel (PDCCH). Specifically, the UE 100 blind decodes the PDCCH using a radio network temporary identifier (RNTI) and acquires successfully decoded DCI as DCI addressed to the UE 100. The DCI transmitted from the gNB 200 is appended with CRC parity bits scrambled using the RNTI.

The MAC layer performs preferential control of data, retransmission processing using a hybrid ARQ (HARQ), a random access procedure, and the like. Data and control information are transmitted between the MAC layer of the UE 100 and the MAC layer of the gNB 200 via a transport channel. The MAC layer of the gNB 200 includes a scheduler. The scheduler determines uplink and downlink transport formats (transport block sizes, modulation and coding schemes (MCSs)), and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between an IP flow as the unit of QoS control by a core network and a radio bearer as the unit of QoS control by an Access Stratum (AS). Note that, when the RAN is connected to the EPC, the SDAP need not be provided.

FIG. 5 is a diagram illustrating a configuration of a protocol stack of a radio interface of a control plane handling signaling (a control signal).

The protocol stack of the radio interface of the control plane includes a Radio Resource Control (RRC) layer and a Non-Access Stratum (NAS) layer instead of the SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When a connection (RRC connection) between the RRC of the UE 100 and the RRC of the gNB 200 is present, the UE 100 is in an RRC connected state. When no connection (RRC connection) between the RRC of the UE 100 and the RRC of the gNB 200 is present, the UE 100 is in an RRC idle state. When the connection between the RRC of the UE 100 and the RRC of the gNB 200 is suspended, the UE 100 is in an RRC inactive state.

The NAS which is positioned upper than the RRC layer performs session management, mobility management, and the like. NAS signaling is transmitted between the NAS of the UE 100 and the NAS of the AMF 300A. Note that the UE 100 includes an application layer other than the protocol of the radio interface. A layer lower than the NAS is referred to as Access Stratum (AS).

### Overview of Cell Reselection Procedure

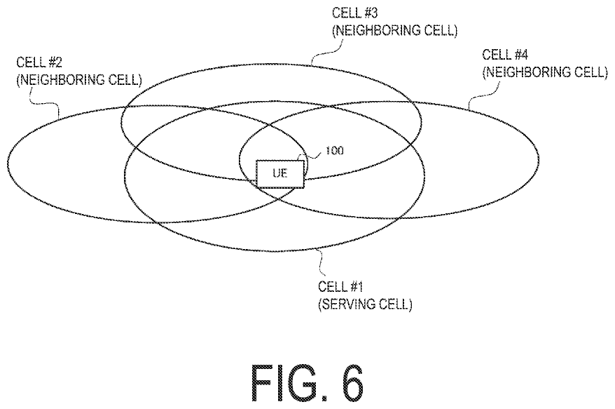

FIG. 6 is a diagram for illustrating an overview of the cell reselection procedure.

The UE 100 in the RRC idle state or the RRC inactive state while moving performs the cell reselection procedure to move from a current serving cell (a cell #1) to a neighboring cell (any one of cells #2 to #4). To be more specific, the UE 100 specifies a neighboring cell on which the UE 100 to camp through the cell reselection procedure and reselects the specified neighboring cell. When the frequency (carrier frequency) is the same between the current serving cell and the neighboring cell is referred to as an intra-frequency, and when the frequency (carrier frequency) is different between the current serving cell and the neighboring cell is referred to as an inter-frequency. The current serving cell and the neighboring cell may be managed by the same gNB 200 or may be managed by the gNBs 200 different from each other.

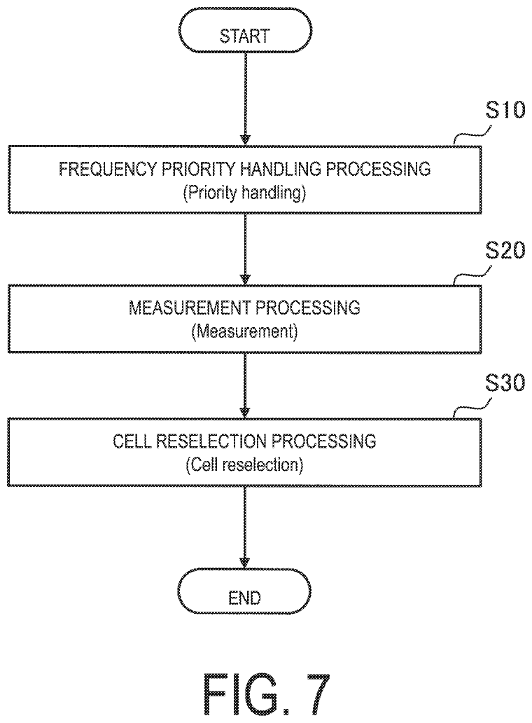

FIG. 7 is a flowchart illustrating a schematic flow of a typical cell reselection procedure.

In step S10, the UE 100 performs frequency priority handling processing based on frequency-specific priorities (also referred to as “absolute priorities”) specified by the gNB 200, for example, by way of a system information block or an RRC release message. To be more specific, the UE 100 manages the frequency priority designated by the gNB 200 for each frequency.

In step S20, the UE 100 performs measurement processing of measuring radio qualities of the serving cell and each of the neighboring cells. The UE 100 measures reception powers and reception qualities of reference signals transmitted by the serving cell and each of the neighboring cells, to be more specific, cell defining-synchronization signal and PBCH block (CD-SSB). For example, the UE 100 measures always the radio quality for a frequency with a priority higher than the priority of the frequency of the current serving cell, and when the radio quality of the current serving cell is lower than a predetermined quality, the UE 100 measures the radio quality for a frequency with a priority equal to or lower than the priority of the frequency of the current serving cell.

In step S30, the UE 100 performs the cell reselection processing of reselecting a cell on which the UE 100 camps based on the measurement result in step S20. For example, the UE 100 may perform cell reselection to a neighboring cell when a priority of a frequency of the neighboring cell is higher than the priority of the current serving cell and when the neighboring cell satisfies a predetermined quality standard (i.e., a minimal quality standard) for a predetermined period of time. When the priories of the frequencies of the neighboring cells are the same as the priority of the current serving cell, the UE 100 may rank the radio qualities of the neighboring cells to perform cell reselection to the neighboring cell ranked higher than a rank of the current serving cell for a predetermined period of time. When the priority of the frequency of the neighboring cell is lower than the priority of the current serving cell, and when the radio quality of the current serving cell is lower than a certain threshold value and the radio quality of the neighboring cell is continuously higher than another threshold value for a predetermined period of time, the UE 100 may perform cell reselection to the neighboring cell.

### Overview of Network Slicing

The network slicing is a technique for virtually dividing a physical network (for example, a network including the NG-RAN 10 and the 5GC 20) constructed by an operator to create a plurality of virtual networks. Each virtual network is referred to as a network slice. Hereinafter, the “network slice” may be simply referred to as a “slice”.

The network slicing allows a communication carrier to create slices according to service requirements of different service types, such as Enhanced Mobile Broadband (eMBB), Ultra-Reliable and Low Latency Communications (URLLC), and massive Machine Type Communications (mMTC), for example, to optimize network resources.

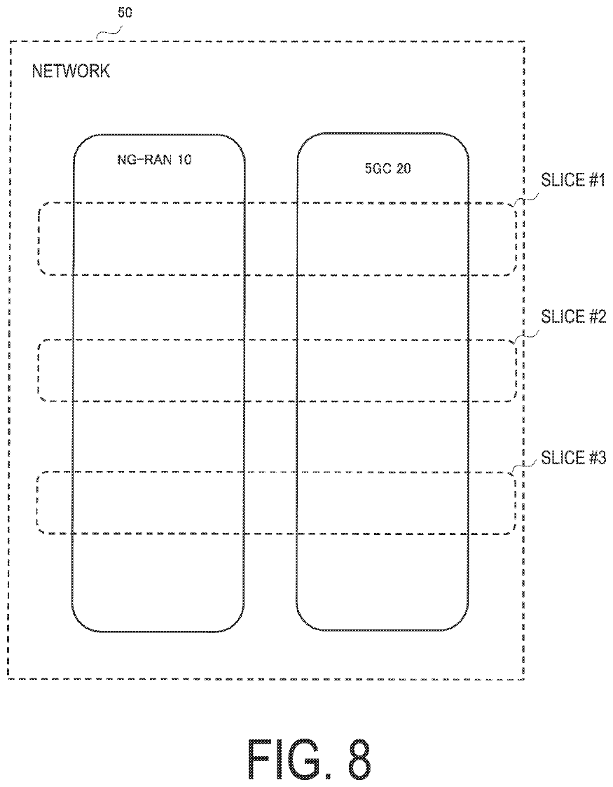

FIG. 8 is a diagram illustrating an example of the network slicing.

Three slices (slices #1 to #3) are configured on a network 50 including the NG-RAN 10 and the 5GC 20. The slice #1 is associated with a service type of eMBB, the slice #2 is associated with a service type of URLLC, and the slice #3 is associated with a service type of mMTC. Note that three or more slices may be configured on the network 50. One service type may be associated with a plurality slices.

Each slice is provided with a slice identifier for identifying the slice. Examples of the slice identifier include a Single Network Slicing Selection Assistance Information (S-NSSAI). The S-NSSAI includes an 8-bit slice/service type (SST). The S-NSSAI may further include a 24-bit slice differentiator (SD). The SST is information indicating a service type with which a slice is associated. The SD is information for differentiating a plurality of slices associated with the same service type. The information including a plurality of pieces of S-NSSAI is referred to as a Network Slice Selection Assistance Information (NSSAI).

One or more slices may be grouped to configure a slice group. The slice group is a group including one or more slices, and a slice group identifier is assigned to the slice group. The slice group may be configured by the core network (for example, the AMF 300), or may be configured by the radio access network (for example, the gNB 200). The UE 100 may be notified of the configured slice group.

Hereinafter, the term “network slice (or slice)” may refer to an S-NSSAI that is an identifier of a single slice or an NSSA that is a collection of S-NSSAIs, or may refer to one or more S-NSSAIs or a slice group that is a group of NSSAIs.

The UE 100 also determines a desired network slice that the UE 100 wants to use. Such a desired slice may be referred to as an intended slice. In the embodiment, the UE 100 determines a slice priority for each network slice (desired network slice). For example, the NAS of the UE 100 determines the slice priority based on an operation status of an application in the UE 100 and/or a user operation/setting, and notifies the AS of the determined slice priority.

### Overview of Slice-Specific Cell Reselection Procedure

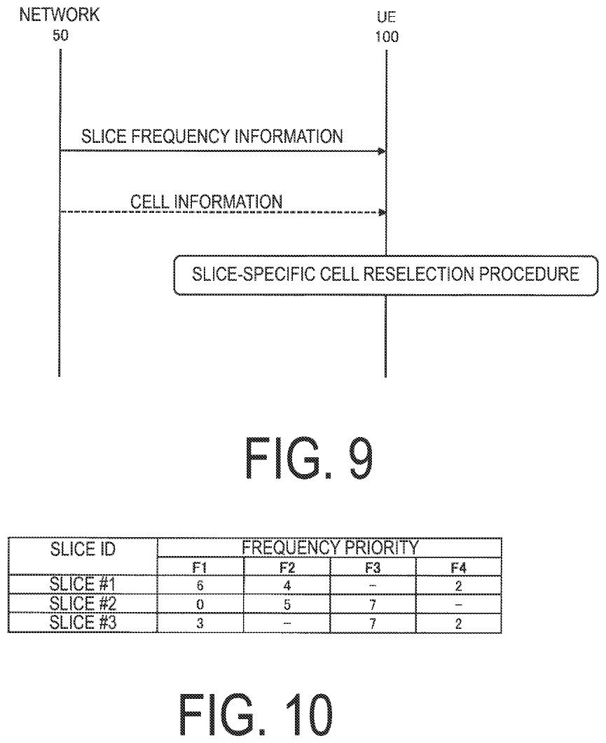

FIG. 9 is a diagram illustrating an overview of the slice-specific cell reselection procedure.

In the slice-specific cell reselection procedure, the UE 100 performs cell reselection processing based on slice frequency information provided from the network 50. The slice frequency information may be provided from the gNB 200 to the UE 100 through broadcast signaling (for example, a system information block) or dedicated signaling (for example, an RRC release message).

The slice frequency information is information indicating a correspondence relationship between network slices, frequencies, and frequency priorities. For example, the slice frequency information indicates, for each slice (or slice group), a frequency (one or more frequencies) that supports the slice and a frequency priority assigned to each frequency. An example of the slice frequency information is illustrated in FIG. 10.

In the example illustrated in FIG. 10, three frequencies F1, F2, and F4 are associated with the slice #1 as frequencies that support the slice #1. Among these three frequencies, the frequency priority of F1 is “6”, the frequency priority of F2 is “4”, and the frequency priority of F4 is “2”. In the example of FIG. 10, the larger the number of the frequency priority, the higher the priority is, but a case in which the smaller the number, the higher the priority is may also be possible.

Three frequencies F1, F2, and F3 are associated with the slice #2 as frequencies that support the slice #2. Among these three frequencies, the frequency priority of F1 is “0”, the frequency priority of F2 is “5”, and the frequency priority of F3 is “7”.

Three frequencies F1, F3, and F4 are associated with the slice #3 as frequencies that support the slice #3. Among these three frequencies, the frequency priority of F1 is “3”, the frequency priority of F3 is “7”, and the frequency priority of F4 is “2”.

Hereinafter, the frequency priority indicated in the slice frequency information may be referred to as a “slice-specific frequency priority” in order to be distinguished from the absolute priority in the conventional cell reselection procedure.

The UE 100 may perform the cell reselection processing further based on cell information provided from the network 50. The cell information may be information indicating a correspondence relationship between a cell (for example, a serving cell and each neighboring cell) and a network slice that is not provided or provided by the cell. For example, a cell may temporarily fail to provide some or all network slices due to congestion or the like. That is, even for a slice support frequency capable of providing a network slice, some cells within the frequency may not provide the network slice. Based on the cell information, the UE 100 may grasp which network slice is not provided by each cell. The cell information like this may be provided from the gNB 200 to the UE 100 through broadcast signaling (for example, a system information block) or dedicated signaling (for example, an RRC release message).

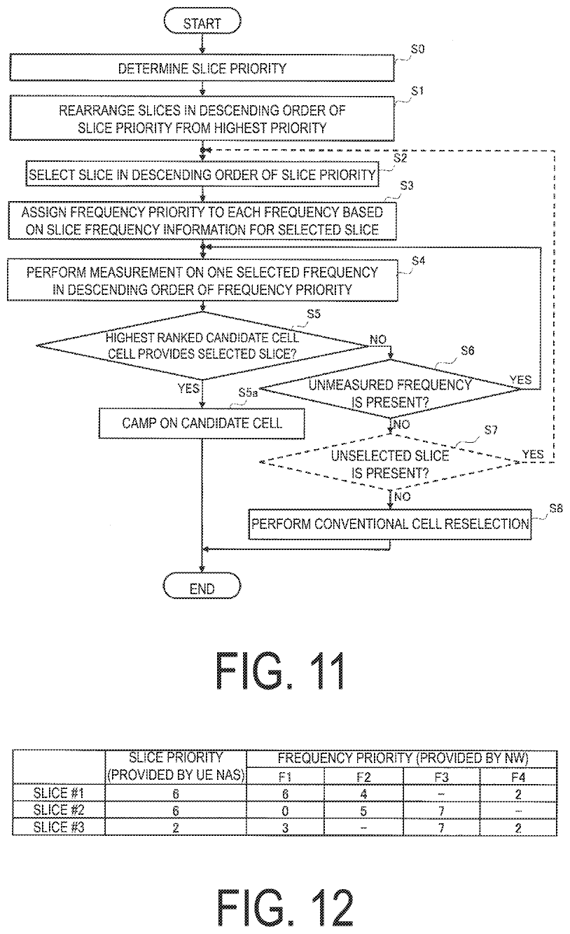

FIG. 11 is a flowchart illustrating a basic flow of the slice-specific cell reselection procedure. Before starting the slice-specific cell reselection procedure, the UE 100 is assumed to be in the RRC idle state or the RRC inactive state, and to receive and retain the above-mentioned slice frequency information.

In step S0, the NAS of UE 100 determines the slice identifiers of the desired slices for the UE 100 and the slice priorities of the desired slices, and notifies the AS of the UE 100 of slice information including the determined slice priorities. The “desired slice” includes a slice that is likely to be used, a candidate slice, a wanted slice, a slice with which communication is desired, a requested slice, an allowed slice, or an intended slice. For example, the slice priority of the slice #1 is determined to be “3”, the slice priority of the slice #2 is determined to be “2”, and the slice priority of the slice #3 is determined to be “1”. The larger the number of the slice priority, the higher the priority is, but a case in which the smaller the number, the higher the priority is may also be possible.

In step S1, the AS of the UE 100 rearranges the slices (slice identifiers), of which the AS is notified by the NAS in step S0, in descending order of slice priority. A list of the slices arranged in this manner is referred to as a “slice list”.

In step S2, the AS of the UE 100 selects one network slice in descending order of slice priority. The network slice selected in this manner is referred to as a “selected network slice”.

In step S3, the AS of the UE 100 assigns, for the selected network slice, a frequency priority to each of the frequencies associated with that network slice. To be more specific, the AS of the UE 100 specifies frequencies associated with the slice based on the slice frequency information and assigns frequency priorities to the specified frequencies. For example, when the selected network slice selected in step S2 is the slice #1, the AS of the UE 100 assigns the frequency priority “6” to the frequency F1, the frequency priority “4” to the frequency F2, and the frequency priority “2” to the frequency F4 according to the slice frequency information (for example, the information in FIG. 10). The AS of the UE 100 refers to a list of frequencies arranged in descending order of frequency priority as a “frequency list”.

In step S4, the AS of the UE 100 selects one of the frequencies in descending order of frequency priority for the selected network slice selected in step S2, and performs the measurement processing on the selected frequency. The frequency selected in this manner is referred to as a “selected frequency”. The AS of the UE 100 may rank the cells measured within the selected frequency in descending order of radio quality. Among the cells measured within the selected frequency, those cells that satisfy a predetermined quality standard (i.e., a minimal quality standard) are referred to as “candidate cells”.

In step S5, the AS of the UE 100 specifies a cell ranked the highest based on the result of the measurement processing in step S4, and determines whether the cell provides the selected network slice based on the cell information. When determining that the highest ranked cell provides the selected network slice (step S5: YES), the AS of the UE 100 reselects the highest ranked cell and camps on that cell in step S5a.

On the other hand, when determining that the highest ranked cell does not provide the selected network slice (step S5: NO), the AS of UE 100 determines in step S6 whether a frequency not measured is present in the frequency list created in step S3. When determining that a frequency not measured is present (step S6: YES), the AS of the UE 100 resumes the processing for the frequency having the next highest frequency priority, and performs the measurement processing by use of that frequency as selected frequency (returns the processing to step S4).

When determining that a frequency not measured is not present in the frequency list created in step S3 (step S6: NO), the AS of the UE 100 may determine in step S7 whether an unselected slice is present in the slice list created in step S1. When determined that an unselected slice is present (step S7: YES), the AS of the UE 100 resumes the processing for the network slice having the next highest slice priority, and selects that network slice as the selected network slice (returns the processing to step S2). Note that in the basic flow illustrated in FIG. 11, the process in step S7 may be omitted.

When determining that an unselected slice is not present (step S7: NO), the AS of the UE 100 performs conventional cell reselection processing in step S8. The conventional cell reselection processing may mean an entirety of a general cell reselection procedure illustrated in FIG. 7, or may mean only cell reselection processing (step S30) illustrated in FIG. 7. In the latter case, the UE 100 may use the measurement result in step S4 without measuring the radio qualities of the cells again.

### First Variation of Slice-Specific Cell Reselection Procedure

A first variation of the slice-specific cell reselection procedure is described.

As described above, the slice information including the slice priorities is provided from the NAS to the AS in step S0. Here, when different slice priorities are assigned to the respective slices, the processing of subsequent steps (for example, steps S1 to S7) can be performed without any particular problem.

On the other hand, a problem may arise when a plurality of slices has the same slice priority. In particular, when different frequency priorities are assigned to these slices, which frequency has a higher priority may not be known. For example, in a configuration as illustrated in FIG. 12, the slice #1 and the slice #2 have the same slice priority “6”. In such a case, which of the slice #1 and the slice #2 having the highest slice priority the corresponding frequency priority is to be applied to is uncertain.

In this variation, the UE 100, which receives, from the network 50 (for example, the gNB 200), the slice frequency information indicating the correspondence relationship between the network slice, the frequencies, and the frequency priorities, assigns the frequency priorities indicated by the slice frequency information to the corresponding frequencies for the selected network slice that is selected in accordance with the slice priority (step S3). The UE 100 reselects a candidate cell satisfying a predetermined quality standard within a selected frequency selected in accordance with the assigned frequency priorities (step S4, S5, S5a).

Here, in the step S3, when a plurality of network slices (specifically, a plurality of desired network slices) have the same slice priority, the UE 100 derives a representative value, for each of the frequencies, based on the frequency priorities for each of the plurality of network slices. Then, the UE 100 assigns the derived representative value to the corresponding frequency as the frequency priority. This makes it possible to appropriately assign the frequency priority of each frequency in consideration of the frequency priorities for the network slices having the same slice priority.

The UE 100, in deriving the representative value, may derive, as the representative value for each frequency, a sum, a mean, a product, or a maximum value of the frequency priorities for the network slices having the same slice priority.

In the example illustrated in FIG. 12, when the “sum” of the frequency priorities for the network slices #1 and #2 having the same slice priority is derived as the representative value, the UE 100 assigns the frequency priorities (representative values) such as
frequency F1: 6,
frequency F2: 9,
frequency F3: 7, and
frequency F4: 2. Therefore, the frequency F2 having a high average frequency priority in the slices #1 and #2 is assigned with the highest frequency priority “9”. As a result, since the UE 100 reselects the candidate cell belonging to the F2 with the highest priority, the UE 100 may easily use both slices #1 and #2 in the camped on frequency F2.

Here, the frequency F3 does not have the frequency priority configured for the slice #1, and thus may not support the slice #1. The frequency F4 does not have the frequency priority configured for the slice #2, and thus may not support the slice #2. When the UE 100 reselects such frequencies F3 and F4, it is difficult for the UE 100 to use both slices #1 and #2. Therefore, when a frequency (frequency F3 or F4) is not assigned with a frequency priority for any of the plurality of network slices having the same slice priority, the UE 100 may exclude the frequency (frequency F3 or F4) from the cell reselection candidates. In the example illustrated in FIG. 12, when the “sum” of the frequency priorities for the network slices #1 and #2 having the same slice priority is derived as the representative value, the UE 100 may assign the frequency priorities (representative values) such as frequency F1: 6, frequency F2: 9, frequency F3: −(N/A), and frequency F4: −(N/A).

On the other hand, in the example illustrated in FIG. 12, when the “mean” of the frequency priorities for the network slices #1 and #2 having the same slice priority is derived as the representative value, the UE 100 assigns the frequency priorities (representative values) such as
frequency F1: 1,
frequency F2: 4.5,
frequency F3: 3.5, and
frequency F4: 1. Therefore, the frequency F2 having a high average frequency priority in the slices #1 and #2 is assigned with the highest frequency priority “4.5”. When a frequency (frequency F3 or F4) is not assigned with a frequency priority for any of the plurality of network slices having the same slice priority, the UE 100 may exclude the frequency (frequency F3 or F4) from the cell reselection candidates. For example, the UE 100 may assign the frequency priorities (representative values) such as
Frequency F1: 3,
Frequency F2: 4.5,
Frequency F3: —(N/A), and
Frequency F4: —(N/A).

Note that although the example is described in which the representative value is the “sum” or the “mean”, the representative value may be the “product” or the “maximum value”, or may be another statistical value.

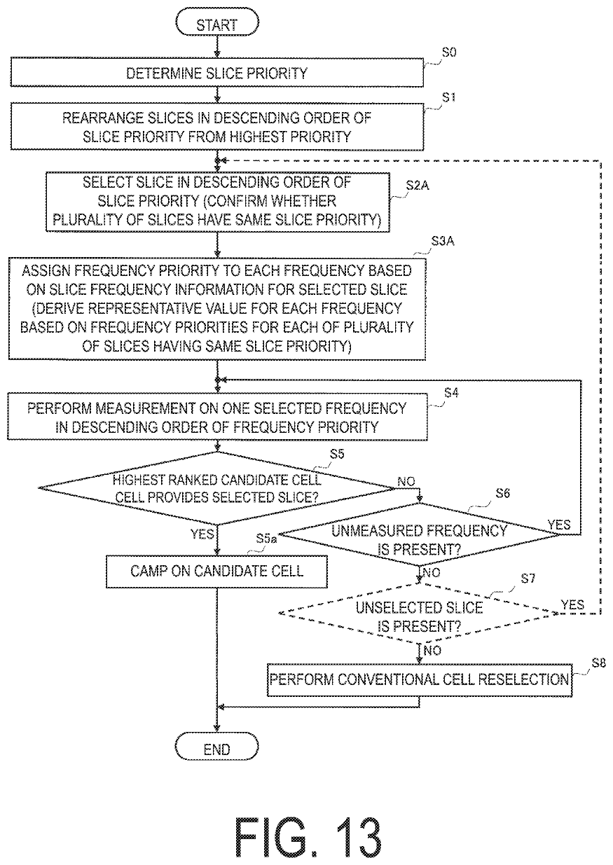

FIG. 13 is a flowchart illustrating a flow of the slice-specific cell reselection procedure according to this variation. Here are described differences from the basic flow (FIG. 11) of the slice-specific cell reselection procedure described above.

In step S2A, the AS of the UE 100 may confirm whether a plurality of slices have the same slice priority. In other words, the AS of the UE 100 may confirm whether the same slice priority is assigned to a plurality of slices by the NAS.

In step S3A, the AS of the UE 100 assigns, as the frequency priority to each of the frequency priorities assigned for the plurality of slices having the same slice priority, a representative value (for example, a sum, a mean, a product, or a maximum) of the values of the frequency priorities. Here, when a frequency priority is not assigned for any of the slices, the UE 100 may determine that no priority is applied to the corresponding frequency. For example, when a plurality of slices having the same slice priority exist, the UE 100 assigns frequency priorities only when all of these slices have frequency priorities. In other words, when a plurality of slices having the same slice priority exist, the UE 100 does not assign a frequency priority to a frequency having no frequency priority for one or more slices.

### Second Variation of Slice-Specific Cell Reselection Procedure

A second variation of the slice-specific cell reselection procedure is described.

With respect to a plurality of slices to which the same slice priority is assigned by the NAS, there is no indication of intention as to which slice is to be prioritized, and it can be considered that either slice may be prioritized. Therefore, in this variation, for a plurality of slices to which the same slice priority is assigned, the frequency having the highest frequency priority is to be measured to reselect the best cell by ranking.

In this variation, the UE 100, which receives, from the network, the slice frequency information indicating the correspondence relationship between the network slice, the frequencies, and the frequency priorities, assigns the frequency priorities indicated by the slice frequency information to the corresponding frequencies for the selected network slice that is selected in accordance with the slice priority. When the plurality of network slices have the same slice priority, the UE 100 specifies a highest-priority frequency having the highest frequency priority for each of the plurality of network slices, and reselects a candidate cell satisfying a predetermined quality standard within the highest-priority frequency for each of the plurality of network slices.

A description is given using FIG. 12 as an example, the UE 100 specifies the highest-priority frequency having the highest frequency priority for each of the network slices #1 and #2 having the same slice priority “6”. The highest-priority frequency for the network slice #1 is the frequency F1, to which the highest frequency priority “6” is assigned, among the frequencies F1 to F4. The highest-priority frequency for the network slice #2 is the frequency F3, to which the highest frequency priority “7” is assigned, among the frequencies F1 to F4. Therefore, the UE 100 specifies the frequencies F1 and F3, and performs control to reselect the cell with the highest rank (the highest ranked) from among the cells belonging to the frequencies F1 and F3. Here, the UE 100 may measure the frequencies F1 and F3 at different timings. When the UE 100 includes a plurality of RF circuits (a plurality of reception devices), the UE 100 may simultaneously measure the frequencies F1 and F3.

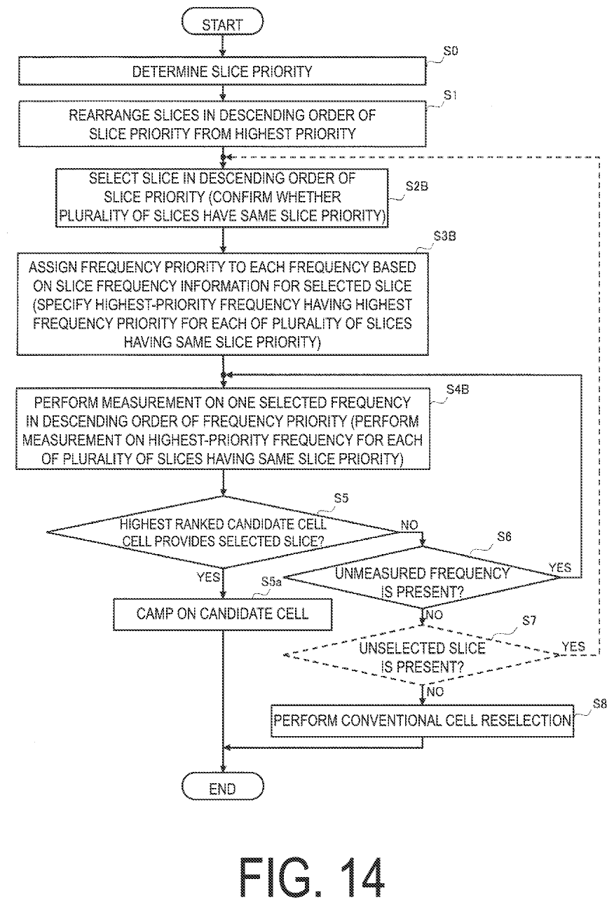

FIG. 14 is a flowchart illustrating a flow of the slice-specific cell reselection procedure according to this variation. Here are described differences from the basic flow (FIG. 11) of the slice-specific cell reselection procedure described above.

In step S2B, the AS of the UE 100 may confirm whether a plurality of slices have the same slice priority. In other words, the AS of the UE 100 may confirm whether the same slice priority is assigned to a plurality of slices by the NAS.

In step S3B, the AS of the UE 100 specifies the highest-priority frequency for each of the plurality of slices having the same slice priority.

In step S4B, the AS of the UE 100 AS performs measurement on each cell on each highest-priority frequency specified in step S3B. The AS of the UE 100 ranks the measured cells (cells of a plurality of frequencies) and specifies the highest ranked candidate cell.

### Third Variation of Slice-Specific Cell Reselection Procedure

A third variation of the slice-specific cell reselection procedure is described.

The problems of the first and second variations described above can be resolved by defining that the NAS always assigns a different slice priority to each slice. In this variation, assume that such a restriction is put in the technical specifications of the NAS.

In this variation, the NAS of the UE 100 assigns a slice priority to each of one or more network slices (to be specific, one or more desired network slices), and notifies the AS of the slice information including the assigned slice priorities. Here, the NAS assigns different slice priorities to two or more network slices so that the same slice priority is not assigned to these two or more network slices.

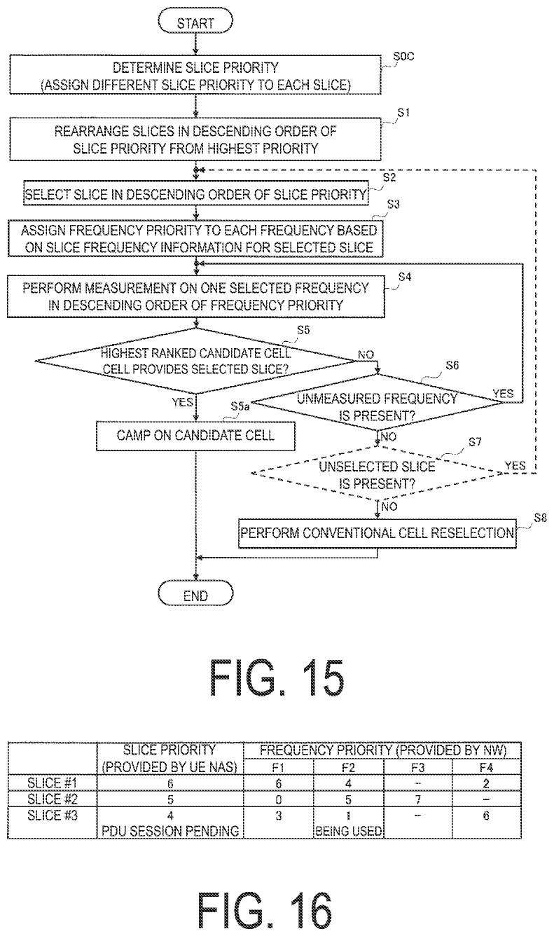

FIG. 15 is a flowchart illustrating a flow of the slice-specific cell reselection procedure according to this variation. Here are described differences from the basic flow (FIG. 11) of the slice-specific cell reselection procedure described above.

In step S0C, the NAS of the UE 100 determines to provide the slice information to the AS and determines the slice priority for each desired network slice. For example, the NAS may determine the slice priority according to a request of the application layer or may be configured from the AMF.

Here, the NAS assigns a different slice priority to each slice. For example, when the slice priorities are the same among the slices in the request of the application layer or the configuration from the AMF, the NAS assigns a different slice priority to each slice in accordance with, for example, the use frequency and the use time of the application. Then, the NAS provides the slice information including the assigned slice priorities to the AS.

### Fourth Variation of Slice-Specific Cell Reselection Procedure

A fourth variation of the slice-specific cell reselection procedure is described.

The cell reselection procedure is performed with the UE 100 being in the RRC idle state or the RRC inactive state. Here, when the UE 100 is in the RRC inactive state, the UE 100 has a pending protocol data unit (PDU) session. Since such a pending PDU session is expected to be resumed by RRC connection resume, it may be preferable to increase the slice priority of the slice with the pending PDU session.

For example, in the state illustrated in FIG. 16, when the slice priorities of the slices #1 and #2 which are not used in the pending PDU session are higher than the slice priority of the slice #3 which is used in the pending PDU session, it is not preferable that the slice #3 with the pending PDU session is postponed. Therefore, in this variation, the NAS of the UE 100 handles the slice with the pending PDU session as having a slice priority equal to or higher than the highest slice priority in each slice of the desired network slices.

In this variation, the NAS of the UE 100 assigns a slice priority to each of one or more network slices (one or more desired network slices), and notifies the AS of the slice information including the assigned slice priorities. The NAS specifies the network slice with the pending PDU session (the slice #3 in the example of FIG. 16) and notifies the AS of information based on the specified network slice.

The NAS may assign the highest slice priority to the network slice with the pending PDU session.

Here, the highest slice priority may be a slice priority that is the same as the highest slice priority of a network slice other than the network slice with the pending PDU session. In the example of FIG. 16, the NAS of the UE 100 may assign, to the slice #3, the highest slice priority “6” of the slices (#1 and #2) other than the slice #3 with the pending PDU sessions. In this example, since the slice priority of the slice #3 is the same as the slice priority of the slice #1, the operations of the above-described first and second variations can be applied.

Alternatively, the highest slice priority may be a slice priority that is higher than the highest slice priority of a network slice other than the network slice with the pending PDU session. In the example of FIG. 16, the NAS of the UE 100 may assign, to the slice #3, the slice priority “7” which is higher than the highest slice priority “6” of the slices (#1 and #2) other than the slice #3 with the pending PDU sessions.

Note that the NAS of the UE 100 may specify the network slice with the pending PDU session in the following manner. To be more specific, the NAS of the UE 100 may specify the network slice with the pending PDU session in accordance with being notified by the AS that the UE 100 has transitioned to the RRC inactive state. For example, the AS of the UE 100, when receiving an RRC Release message including Suspend config. from the gNB 200, performs processing for transitioning to the RRC inactive state and notifies the NAS that the UE 100 has transitioned to the RRC inactive state. The NAS of the UE 100 specifies the currently established (pending) PDU session and the slice associated with the PDU session. The NAS of the UE 100, when specifying one or more slices (Intended Slices), may notify the AS of the slices (identifiers) as the desired network slices. The desired network slices may be given by notification to the AS as part of the Intended Slices. In other words, after transitioning to the RRC inactive state, the AS receives a notification of the Intended slices (as updated Intended slices) from the NAS.

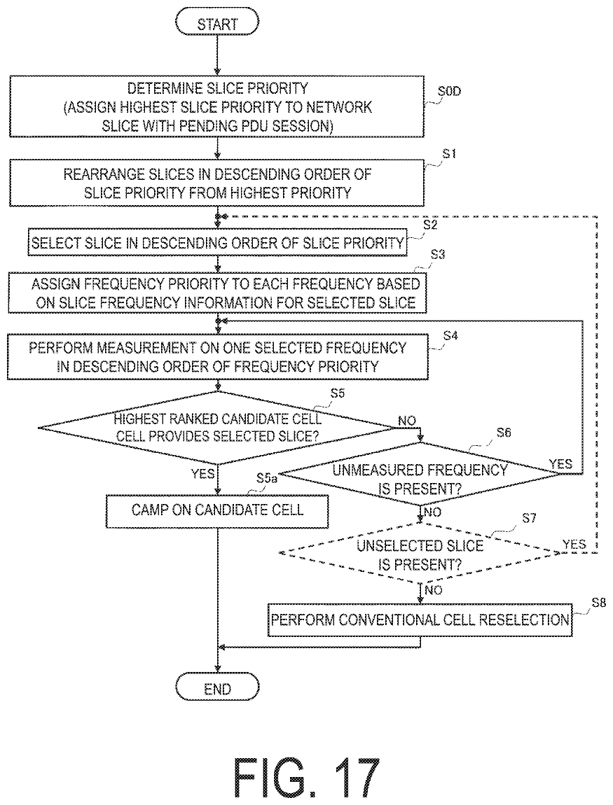

FIG. 17 is a flowchart illustrating a flow of the slice-specific cell reselection procedure according to this variation. Here are described differences from the basic flow (FIG. 11) of the slice-specific cell reselection procedure described above.

In step S0D, when the PDU session is pending, the NAS of the UE 100 handles the corresponding slice (identifier) as having the highest slice priority the same as of the Intended Slice. In the example of FIG. 16, the NAS of the UE 100 may regard the slice priority of the slice #3 as “6” or as a slice priority higher than “6”. Alternatively, the AS may perform the processing of the slice-specific cell reselection procedure (after step S1) in accordance with the (updated) Intended Slice.

### Other Embodiments

The operation flows described above can be separately and independently implemented, and also be implemented in combination of two or more of the operation flows. For example, some steps of one operation flow may be added to another operation flow or some steps of one operation flow may be replaced with some steps of another operation flow.

In the embodiment and examples described above, an example in which the base station is an NR base station (i.e., a gNB) is described; however, the base station may be an LTE base station (i.e., an eNB) or a 6G base station. The base station may be a relay node such as an Integrated Access and Backhaul (IAB) node. The base station may be a DU of an IAB node. The user equipment may be a Mobile Termination (MT) of the IAB node.

A program causing a computer to execute each of the processes performed by the UE 100 or the gNB 200 may be provided. The program may be recorded in a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM. Circuits for executing the processes to be performed by the UE 100 or the gNB 200 may be integrated, and at least part of the UE 100 or the gNB 200 may be configured as a semiconductor integrated circuit (a chipset or an SoC).

Embodiments have been described above in detail with reference to the drawings, but specific configurations are not limited to those described above, and various design variation can be made without departing from the gist of the present disclosure.

The phrases “based on” and “depending on” used in the present disclosure do not mean “based only on” and “only depending on,” unless specifically stated otherwise. The phrase “based on” means both “based only on” and “based at least in part on”. Similarly, the phrase “depending on” means both “only depending on” and “at least partially depending on”. “Obtain” or “acquire” may mean to obtain information from stored information, may mean to obtain information from information received from another node, or may mean to obtain information by generating the information. The terms “include”, “comprise” and variations thereof do not mean “include only items stated” but instead mean “may include only items stated” or “may include not only the items stated but also other items”. The term “or” used in the present disclosure is not intended to be “exclusive or”. Further, any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a,” “an,” and “the” are added in the present disclosure through translation, these articles include the plural unless clearly indicated otherwise in context.

1. A cell reselection method performed by a user equipment in a mobile communication system, the cell reselection method comprising:
receiving, from a network, slice frequency information the slice frequency information indicating a correspondence relationship between a network slice group, a frequency, and a frequency priority;
determining, for a selected network slice group selected by a user equipment in accordance with a slice group priority, priority orders of corresponding frequencies, based on the frequency priority indicated by the slice frequency information; and
reselecting a candidate cell satisfying a predetermined quality standard within a selected frequency selected by the user equipment in accordance with the determined priority orders,
wherein the determining of the priority orders comprises when a plurality of network slice groups has a same slice group priority, determining, the priority orders of the corresponding frequencies, based on a maximum value of the frequency priority for each of a plurality of network slice groups for each of the frequencies.

2. The cell reselection method according to claim 1, further comprising:
performing, when a frequency exists that is not assigned with the frequency priority for any of the plurality of network slice groups, control in which the frequency is not likely to be selected as the selected frequency.

3. A user equipment comprising:
a circuitry configured to perform:
processing of receiving, from a network, slice frequency information indicating a correspondence relationship between a network slice group, a frequency, and a frequency priority;
processing of determining, for a selected network slice group selected by the user equipment in accordance with a slice group priority, priority orders of corresponding frequencies based on the frequency priorities indicated by the slice frequency information; and
processing of reselecting a candidate cell satisfying a predetermined quality standard within a selected frequency selected by the user equipment in accordance with the determined priority orders,
wherein the processing of determining the priority orders comprises processing of when a plurality of network slice groups has a same slice group priority, determining, the priority orders of the corresponding frequencies, based on a maximum value of the frequency priority for each of a plurality of network slice groups for each of the frequencies.

4. A chipset for controlling a user equipment, the chipset configured to execute processing of:
receiving, from a network, slice frequency information the slice frequency information indicating a correspondence relationship between a network slice group, a frequency, and a frequency priority;
determining, for a selected network slice group selected by a user equipment in accordance with a slice group priority, priority orders of corresponding frequencies, based on the frequency priority indicated by the slice frequency information; and
reselecting a candidate cell satisfying a predetermined quality standard within a selected frequency selected by the user equipment in accordance with the determined priority orders,
wherein the determining of the priority orders comprises when a plurality of network slice groups has a same slice group priority, determining, the priority orders of the corresponding frequencies, based on a maximum value of the frequency priority for each of a plurality of network slice groups for each of the frequencies.

5. A non-transitory computer-readable medium comprising, stored thereupon, computer program instructions for execution by a user equipment, the program instructions being configured to cause the user equipment to execute processing of:
receiving, from a network, slice frequency information the slice frequency information indicating a correspondence relationship between a network slice group, a frequency, and a frequency priority;
determining, for a selected network slice group selected by a user equipment in accordance with a slice group priority, priority orders of corresponding frequencies, based on the frequency priority indicated by the slice frequency information; and
reselecting a candidate cell satisfying a predetermined quality standard within a selected frequency selected by the user equipment in accordance with the determined priority orders,
wherein the determining of the priority orders comprises when a plurality of network slice groups has a same slice group priority, determining, the priority orders of the corresponding frequencies, based on a maximum value of the frequency priority for each of a plurality of network slice groups for each of the frequencies.

6. A mobile communication system comprising:
a user equipment configured to:
receive, from a network, slice frequency information the slice frequency information indicating a correspondence relationship between a network slice group, a frequency, and a frequency priority;
determine, for a selected network slice group selected by a user equipment in accordance with a slice group priority, priority orders of corresponding frequencies, based on the frequency priority indicated by the slice frequency information; and
reselect a candidate cell satisfying a predetermined quality standard within a selected frequency selected by the user equipment in accordance with the determined priority orders, wherein
the user equipment is configured to when a plurality of network slice groups has a same slice group priority, determine, the priority orders of the corresponding frequencies, based on a maximum value of the frequency priority for each of a plurality of network slice groups for each of the frequencies.
